(19) United States
(12) Patent Application Publication
(10) Pub. No.: US 2015/0286099 A1
(43) Pub. Date: Oct. 8, 2015

(54) Compensation Architecture of Liquid Crystal Panel and Liquid Crystal Display Device

(71) Applicant: Shenzhen China Star Optoelectronics Technology Co., Ltd., Shenzhen, Guangdong (CN)

(72) Inventors: Chih-tsung Kang, Shenzhen City (CN); Bo Hai, Shenzhen City (CN)

(21) Appl. No.: 14/358,627

(22) PCT Filed: Apr. 11, 2014
(86) PCT No.: PCT/CN2014/075150

§ 371 Date: May 15, 2014

(30) Foreign Application Priority Data
Apr. 4, 2014 (CN) 201410136880.5

(51) Int. Cl. G02F 1/13363; G02F 1/1335

(52) U.S. Cl. CPC G02F 1/133634; G02F 1/133528; G02F 1/1336; G02F 2413/12

(57) ABSTRACT

The present invention discloses a compensation architecture of a liquid crystal panel, which comprises a sequentially stacked protective film, a first polarizing film, a biaxial compensation film, a liquid crystal panel, a second protective film, a second polarizing film and a third protective film, the liquid crystal panel is provided a liquid crystal layer including a plurality of liquid crystal molecules, the refractive index anisotropy of the liquid crystal layer is Δn, the thickness is d, the pretilt angle of liquid crystal molecules is θ; the compensation thickness of the biaxial compensation film is Rth1; the compensation thickness of the second protective film is Rth2, wherein: 287.3 nm≦Δn×d≦305.7 nm; 85°≦θ<90°; 180 nm≦Rth1≦260 nm; Y1 nm≦Rth2≦Y2 nm; Y1=−0.885×Rth1+241.9; Y2=−0.006638×(Rth1) 2+1.95×Rth1−6.3. The present invention also discloses a liquid crystal display device, which comprises the liquid crystal display panel compensated by using the aforementioned compensation architecture.

### BACKGROUND OF THE INVENTION

1. Field of the Invention

The present invention relates to the liquid crystal display technical field, and in particular to a compensation architecture of a liquid crystal panel and a liquid crystal display device.

2. The Related Arts

Liquid Crystal Display, LCD, is a thin flat display device, it consists of a number of color or monochrome pixels, which is placed in front of the light source or the reflector. The power consumption of the LCD is less. Otherwise, it also has the feature of the high image quality, small size and light weight. Therefore, it is favored by everyone and becomes the mainstream of display. The current LCD is mainly thin film transistor, TFT, LCD.

Along with the growing area of the TFT-LCD, the view angle increases continuously, the contrast of the screen becomes lower, the picture clarity declines, this is a result of the birefringence of the liquid crystal molecules in the liquid crystal layer changing with the viewing angle varying. For ordinary LCD screen, when watching the ordinary LCD screen, we will find its rapid loss of brightness (darker) and discoloration. The traditional LCD typically has 90 degrees viewing angle, it is namely 45 degrees on the left side and right side. The line liquid crystal used to produce LCD panel is a material having birefringence Δn, when light passes through the liquid crystal molecules, it divides into ordinary ray and extraordinary ray two lights, if the incident light on the liquid crystal molecules is oblique, it will produce two refracted lights, the birefringence Δn=ne−no, ne is the refractive index of the liquid crystal molecules versus the ordinary light, no is refractive index of the liquid crystal molecules versus the very light. Therefore, after the light passing through the liquid crystal clamped by the upper and lower glasses, the light will produce a phase retardation phenomenon. The characteristics of the liquid crystal cell is usually measured by phase retardation Δn×d, also known as the optical path difference, Δn is the birefringence, d is the thickness of the liquid crystal cell, the difference of the phase retardation under the different perspective of the liquid crystal cell is the origin of the viewing angle problems. A good phase retardation of the optical compensation can be offset with the phase retardation of the line liquid crystal, thereby widening the viewing angle of the LCD panel. The principle of the optical compensation film is generally to calibrate the phase difference generated by the liquid crystal in different perspective, symmetrically compensating the birefringence of the liquid crystal molecules. Using the optical compensation film to compensate can effectively reduce the light leakage of the dark screen, and it can greatly improve the contrast of the screen in a certain perspective. The optical compensation film can be distinguished to the phase retardation film simply changing phase, the color compensation film, the expanded perspective film and so on from its functional purpose. The optical compensation film can reduce the amount of the light leakage of LCD in dark state, and it can significantly improve the image contrast, color, and overcome partial gray-scale inversion problem in a certain perspective. Main parameters of measuring the properties of the optical compensation film comprise the inner surface compensation value Ro in the plane direction, the thickness compensation value Rth in the thickness direction, the refractive index N, and the film thickness D, which Satisfies the following relationship:

Ro=(Nx−Ny)×D;

Rth=[(Nx+Ny)/2−Nz]×D;

Wherein, Nx is the refractive index along the slow axis (having a maximum refractive index axis; namely, the vibration direction of light having a slower velocity of propagation) in the film plane, Ny is the refractive index along the fast axis (having a minimum refractive index axis; namely, the vibration direction of light having a fast propagation rate, perpendicular to Nx) in the film plane, Nz is the refractive index in the film plane direction (perpendicular to Nx and Ny).

For the different liquid crystal display mode, which namely is the different liquid crystal cell type, the used optical compensation film is also different; moreover, Ro and Rth also need to adjust to an appropriate value. Most of the optical compensation film used by the existing large-size LCD TV is against VA (Vertical Alignment) mode display, during the early stage it is used by Konica's N-TAC, subsequently evolving and forming to OPTES's Zeonor, Fujitsu's F-TAC Series, Nitto Denko's X-plate and so on.

In the existing compensation method, generally using a single or double biaxial compensation structure, the single biaxial compensation structure only needs to provide a compensation film on the one side of the liquid crystal panel, the double biaxial compensation structure needs to provide a compensation film on both sides of the liquid crystal panel, it can only be compensated by adjusting the compensation value of the biaxial compensation film. Referring to FIGS. 1a, 1b, 2a and 2b, FIG. 1a is a profile distribution of the dark full viewing angle isoluminant of the liquid crystal panel after the conventional single-layer biaxial compensation structure compensating; FIG. 1b is a profile distribution of the full viewing angle contrast of the liquid crystal panel after the aforementioned single-layer biaxial compensation structure compensating; FIG. 2a is a profile distribution of the dark full viewing angle isoluminant of the liquid crystal panel after the conventional double-layer biaxial compensation structure compensating; FIG. 2b is a profile distribution of the full viewing angle contrast of the liquid crystal panel after the aforementioned double-layer biaxial compensation structure compensating. As shown in FIGS. 1a and 1b, using the existing single-layer biaxial compensation structure to compensate, the light leakage on the horizontal angle phi=20˜40°, phi=140˜160°, phi=200˜220° and phi=310˜330° is serious; namely, the perspective of the liquid crystal panel which the dark state light leakage is serious is closer to horizontal viewing angle; as shown in FIGS. 2a and 2b, using the existing double-layer biaxial compensation structure to compensate, the perspective of the liquid crystal panel which the dark state light leakage is serious is in the middle of the horizontal and vertical viewing angle. Because the relative position of TV and the audiences determines that the region near the horizontal viewing angle can be more easily seen by the audiences, closing to the contrast and sharpness of the horizontal viewing angle greatly affects the viewing experience, because the area near the vertical viewing angle is not easy to be seen, less affecting the audiences, with the increase of the size of the TV, this effect will become more apparent; therefore, it is necessary to define the dark state light leakage area around the vertical angle.

Consequently, under the existing single-layer or double-layer biaxial compensation structure mode, although using the double-layer biaxial compensation structure to compensate, the perspective of the liquid crystal panel which the dark state light leakage is serious is in the middle of the horizontal and vertical viewing angle, relating to the single-layer biaxial compensation structure has a slight improvement, but the double-layer biaxial compensation structure is more expensive, which is not conducive to reducing costs, and the improvement is limited. Although using the single-layer biaxial compensation structure to compensate can effectively reduce the costs, the dark state light leakage of the liquid crystal closing to the horizontal perspective is serious, low contrast, affecting the viewing experience.

### SUMMARY OF THE INVENTION

In order to improve the deficiency of the prior art, the present invention provides a compensation architecture of a liquid crystal panel, through setting a reasonable compensation value, it can deflect the angle which the dark state light leakage of the liquid crystal panel is serious from the horizontal viewing angle region to the vertical viewing angle region; moreover, it can effectively reduce the dark state light leakage of the liquid crystal panel and ensure that the light leakage concentrate in the smaller range.

In order to achieve the above purpose, the present invention using the following technical solution:

A compensation architecture of a liquid crystal panel, which comprises a sequentially stacked protective film, a first polarizing film, a biaxial compensation film, a liquid crystal panel, a second protective film, a second polarizing film and a third protective film, wherein the liquid crystal panel is provided a liquid crystal layer including a plurality of liquid crystal molecules, the refractive index anisotropy of the liquid crystal layer is Δn, the thickness is d, the pretilt angle of liquid crystal molecules is θ; the compensation thickness of the biaxial compensation film is Rth1; the compensation thickness of the second protective film is Rth2, wherein:

287.3 nm≦Δn×d≦305.7 nm;

85°≦θ<90°;

180 nm≦Rth1≦260 nm;

Y1 nm≦Rth2≦Y2 nm;

Y1=−0.885×Rth1+241.9;

Y2=−0.006638×(Rth1) 2+1.95×Rth1−6.3

Wherein 290 nm≦Δn×d≦303 nm.

Wherein 200 nm≦Rth1≦240 nm; 59 nm≦Rth2≦88.5 nm.

Wherein the compensation thickness Rth2 of the second protective film is chosen 59 nm.

Wherein the material of the first polarizing film and the second polarizing film is polyvinyl alcohol.

Wherein the materials of the first protective film, the second protective film and the third protective film are cellulose triacetate.

Wherein the angle between the absorption axis of the first polarizing film and the slow axis of the biaxial compensation film is 90°.

Wherein the liquid crystal panel is the vertical alignment.

On the other hand, the present invention provides a liquid crystal display device, which comprises a liquid crystal display panel and a backlight module, the liquid crystal display panel and the backlight module being disposed relatively, the backlight module providing a display light to the liquid crystal display panel in order to make the liquid crystal display panel display the image, wherein the liquid crystal display panel using the liquid crystal panel having the compensation architecture as described above.

Relating to the prior art, in the present invention, through setting a reasonable compensation of the biaxial compensation film and the second protective film, it can deflect the angle which the dark state light leakage of the liquid crystal panel is serious from the horizontal viewing angle region to the vertical viewing angle region; moreover, it can effectively reduce the dark state light leakage of the liquid crystal panel and ensure that the light leakage concentrate in the smaller range. Compensating by combining the single-layer biaxial compensation film and the second protection film can not only solve the issue of using the single-layer biaxial compensation film, but also reduce the costs of the double-layer biaxial compensation film compensation.

### BRIEF DESCRIPTION OF THE DRAWINGS

FIG. 1a is a profile distribution of the dark full viewing angle isoluminant of the liquid crystal panel after the conventional single-layer biaxial compensation structure compensating.

FIG. 1b is a profile distribution of the full viewing angle contrast of the liquid crystal panel shown in FIG. 1a.

FIG. 2a is a profile distribution of the dark full viewing angle isoluminant of the liquid crystal panel after the conventional double-layer biaxial compensation structure compensating.

FIG. 2b is a profile distribution of the full viewing angle contrast of the liquid crystal panel shown in FIG. 2a.

FIG. 3 is an exemplary illustration of the liquid crystal display device provided by the embodiment of the present invention.

FIG. 4 is an exemplary illustration of the single-layer biaxial compensation structure provided by the embodiment of the present invention.

FIG. 5 is a trend graph of the leakage amount changing with the compensation value when the dark state light leakage concentrates to the large viewing angle and the liquid crystal optical path difference of the liquid crystal display device of the embodiment of the present invention is 287.3 nm and the pre-tilt angle θ is 89°.

FIG. 6 is a trend graph of the leakage amount changing with the compensation value when the dark state light leakage concentrates to the large viewing angle and the liquid crystal optical path difference of the liquid crystal display device of the embodiment of the present invention is 290 nm and the pre-tilt angle θ is 89°.

FIG. 7 is a trend graph of the leakage amount changing with the compensation value when the dark state light leakage concentrates to the large viewing angle and the liquid crystal optical path difference of the liquid crystal display device of the embodiment of the present invention is 303 nm and the pre-tilt angle θ is 89°.

FIG. 8 is a trend graph of the leakage amount changing with the compensation value when the dark state light leakage concentrates to the large viewing angle and the liquid crystal optical path difference of the liquid crystal display device of the embodiment of the present invention is 305.7 nm and the pre-tilt angle θ is 89°.

FIG. 9a is a profile distribution of the dark full viewing angle isoluminant of a compensated liquid crystal panel in an embodiment.

FIG. 9b is a profile distribution of the full viewing angle contrast of the liquid crystal panel shown in FIG. 9a.

FIG. 10a is another profile distribution of the dark full viewing angle isoluminant of a compensated liquid crystal panel in an embodiment.

FIG. 10b is a profile distribution of the full viewing angle contrast of the liquid crystal panel shown in FIG. 10a.

FIG. 11a is a profile distribution of the dark full viewing angle isoluminant of a compensated liquid crystal panel in an embodiment.

FIG. 11b is a profile distribution of the full viewing angle contrast of the liquid crystal panel shown in FIG. 11a.

FIG. 12a is the other profile distribution of the dark full viewing angle isoluminant of a compensated liquid crystal panel in an embodiment.

FIG. 12b is a profile distribution of the full viewing angle contrast of the liquid crystal panel shown in FIG. 12a.

### DETAILED DESCRIPTION OF THE PREFERRED EMBODIMENTS

In order to make the purposes, technical solutions and advantages of the present invention more clearly understood, the following combines the preferred embodiment of the present invention and its accompanying drawings to describe in detail.

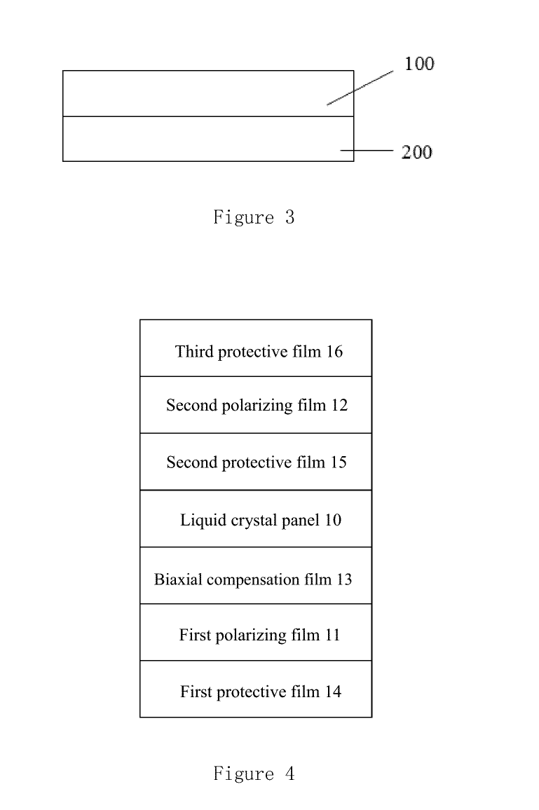

As shown in FIG. 3, a liquid crystal display device provided by the present invention comprises a liquid crystal display panel 100 and a backlight module 200, the liquid crystal display panel 100 and the backlight module 200 are disposed relatively, the backlight module 200 provides a display light to the liquid crystal display panel 100 in order to make the liquid crystal display panel 100 display the image, wherein the liquid crystal display panel 100 is a liquid crystal panel using a compensation architecture to compensate.

Specifically, aforementioned compensation architecture is a single-layer biaxial compensation structure, as shown in FIG. 4, the compensation architecture comprises a first protection film 14, a first polarizing film 11, a biaxial compensation film 13, a liquid crystal panel 10, a second protective film 15, a second polarizing film 12 and a first protective film 16 sequentially stacked from bottom to top (from top to bottom is also possible). Wherein, The liquid crystal panel 10 is a vertical alignment cell, VA cell, the material of the first polarizing film 11 and the second polarizing film 12 is a polyvinyl alcohol, PVA, the angle between the absorbing optical axis of the first polarizing film 11 and the slow axis of the biaxial compensation film is set to 90°, the material of the first protective film 14, the second protective film 15 and the third protective film 16 are triacetyl cellulose, TAC, one effect of the TAC protective film 14,15,16 is used to protect the PVA polarizing film 11, 12, enhance the mechanical properties of the PVA polarizing film 11, 12, preventing the retraction of the PVA polarizing film 11, 12. The liquid crystal panel 10 is provided with a liquid crystal layer comprising a plurality of liquid crystal molecules, the refractive index anisotropy of the liquid crystal layer is Δn, thickness is d, the pritilt angle of the liquid crystal molecules is θ; in the above compensation architecture, the thickness of the biaxial compensation film 13 is represented by Rth1, the thickness of the second protective film 15 is represented by Rth2.

In the above architecture, its purpose is to properly provide the compensation value of the biaxial compensation film 13 and the second protective film 15, achieving to the purpose of deflecting the angle which the dark state light leakage of the liquid crystal panel is serious from the horizontal viewing angle region to the vertical viewing angle region.

In the simulation process, the settings is shown below:

First, setting liquid crystal layer:

1. The pretilt angle θ is 85°≦θ≦90°;

2. The liquid crystal tilt angles of the four quadrants are respectively 45°, 135°, 225° and 315°;

3. The optical path difference Δn×d is 287.3 nm≦Δn×d≦305.7 nm.

Second, setting backlight source:

1. Source: Blue-YAG LED spectrum;

2. Central light source luminance is defined as 100 nit;

3. The light distribution is Lambert's distribution.

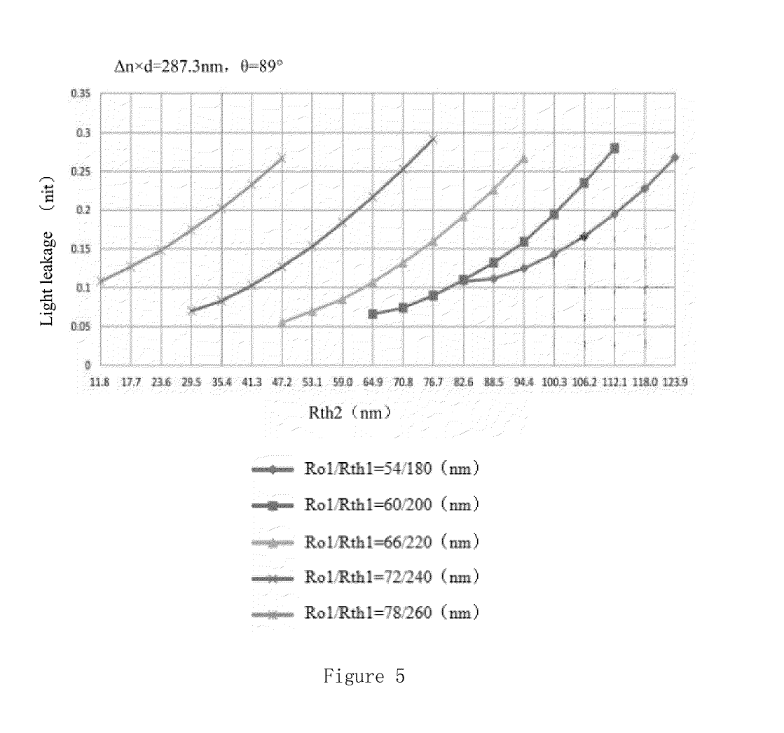

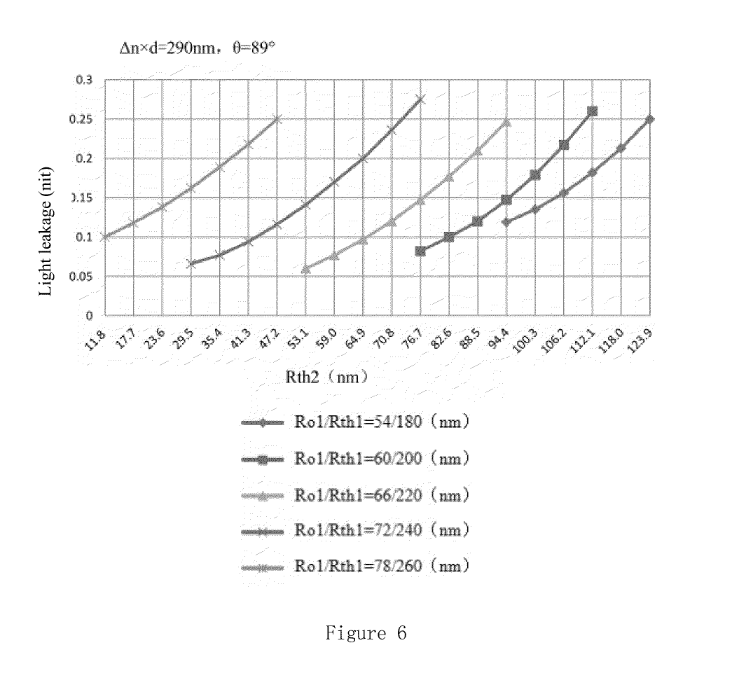

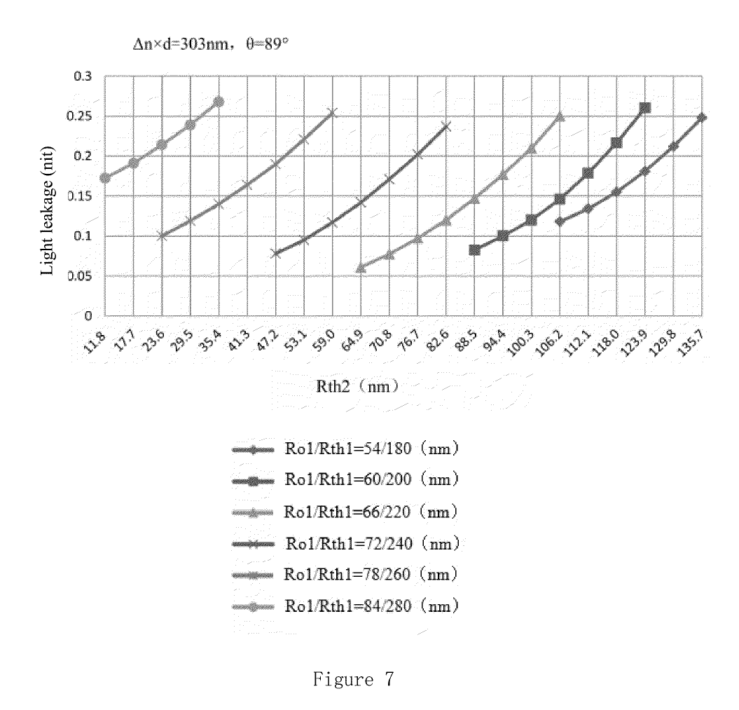

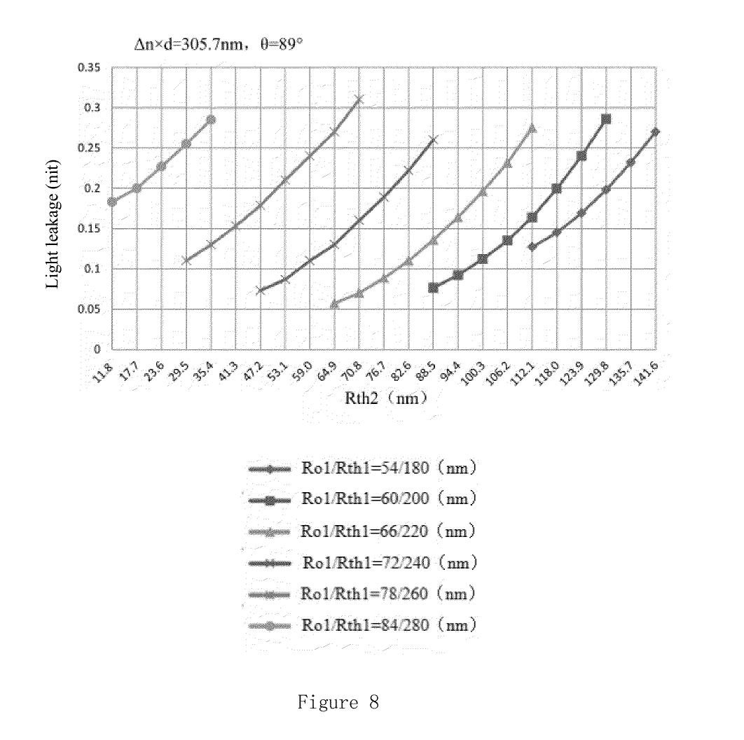

Referring to FIG. 5-8, FIG. 5 is a trend graph of the leakage amount changing with the compensation value when the dark state light leakage concentrates to the large viewing angle and the liquid crystal optical path difference of the liquid crystal display device of the embodiment of the present invention is 287.3 nm and the pre-tilt angle θ is 89°; FIG. 6 is a trend graph of the leakage amount changing with the compensation value when the dark state light leakage concentrates to the large viewing angle and the liquid crystal optical path difference of the liquid crystal display device of the embodiment of the present invention is 290 nm and the pre-tilt angle θ is 89°; FIG. 7 is a trend graph of the leakage amount changing with the compensation value when the dark state light leakage concentrates to the large viewing angle and the liquid crystal optical path difference of the liquid crystal display device of the embodiment of the present invention is 303 nm and the pre-tilt angle θ is 89°; FIG. 8 is a trend graph of the leakage amount changing with the compensation value when the dark state light leakage concentrates to the large viewing angle and the liquid crystal optical path difference of the liquid crystal display device of the embodiment of the present invention is 305.7 nm and the pre-tilt angle θ is 89°; in the drawings, Ro represents the internal plane of the compensation value of the biaxial compensation film 13. Thereby, through FIG. 5-8, simulating with different compensation values in the different pretilt angles, it can obtain that at 287.3 nm≦Δn×d≦305.7 nm, in the range of 85°≦θ≦90°, when the dark state light leakage is less than 0.2 nit, the range of the thickness compensation value Rth1 of the biaxial compensation film 13 and the thickness compensation value Rth2 of the second protective film 12 are respectively: 180 nm≦Rth1≦260 nm; Y1 nm≦Rth2≦Y2 nm; wherein

Y1=−0.885×Rth1+241.9;

Y2=−0.006638×(Rth1) 2+1.95×Rth1−6.3.

Since the compensation value Ro, Rth, the refractive index N and the thickness D of the compensation film have the following relationship:

Ro=(Nx−Ny)×D;

Rth=[(Nx+Ny)/2−Nz]×D;

Therefore, changing the compensation value through the following three methods:

1. On the basis of the refractive index N of the existing biaxial compensation film 13 and the second protective film 15 the same, changing the thickness D to vary the compensation value;

2. On the basis of the refractive thickness D of the existing biaxial compensation film 13 and the second protective film 15 the same, changing the refractive index N to vary the compensation value;

3. On the basis of ensuring the range of the thickness compensation value Rth of the biaxial compensation film 13 and the second protective film 15, simultaneously varying the thickness D and refractive index N to change the compensation value.

The following chooses a specific compensation value and tests the corresponding compensation results, further specific describing the technical effects obtained by the technical solution of the present invention.

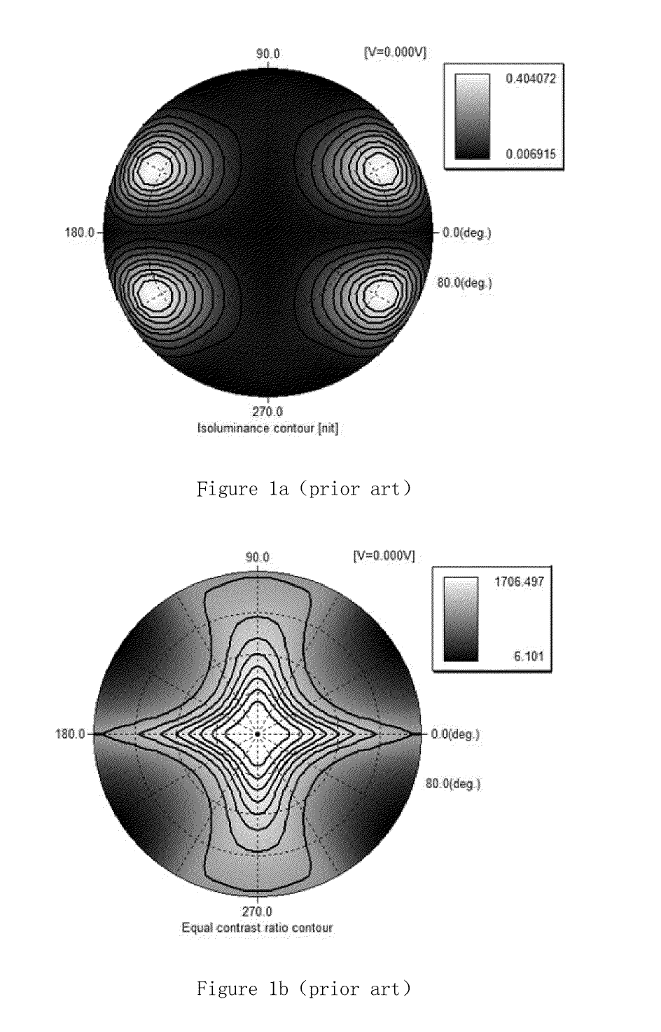

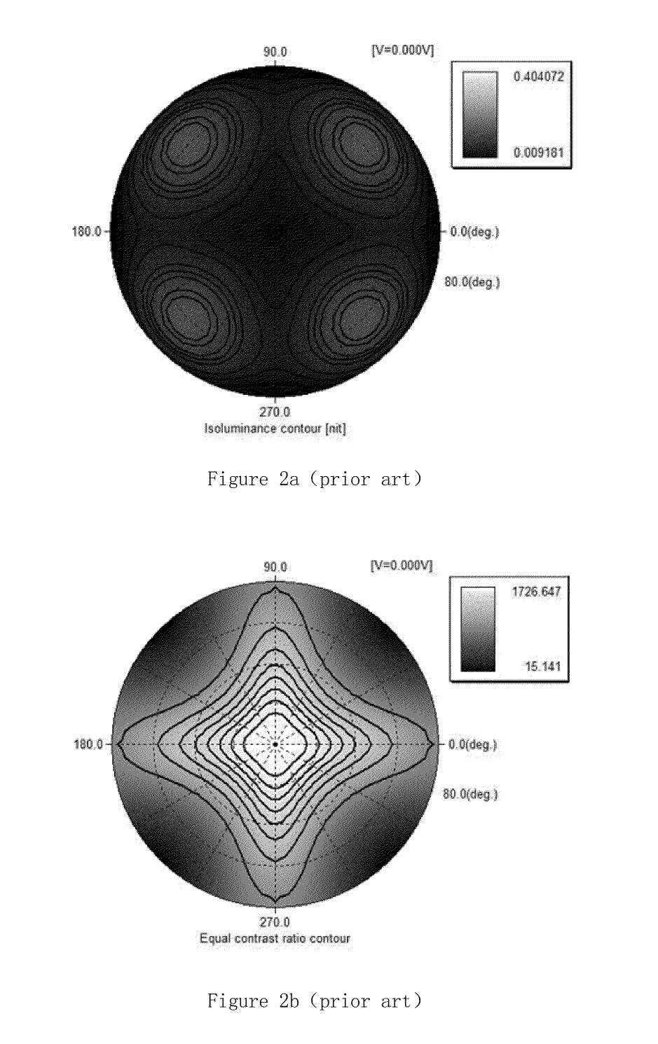

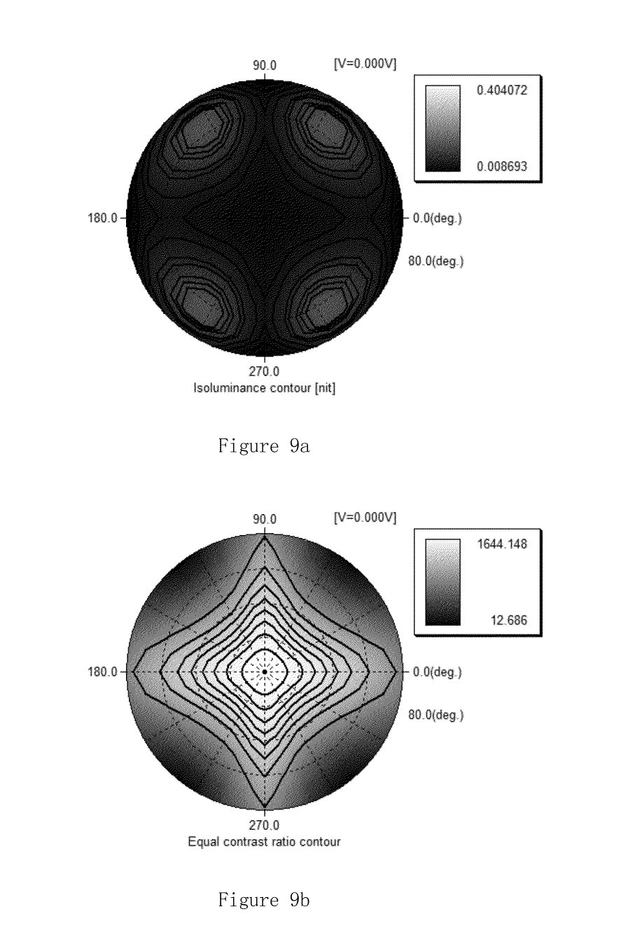

Referring to FIGS. 9a and 9b, FIG. 9a is a profile distribution of the dark full viewing angle isoluminant of a compensated liquid crystal panel in an embodiment, FIG. 9b is a profile distribution of the full viewing angle contrast of the liquid crystal panel shown in FIG. 9a. The setting conditions of FIGS. 9a and 9b are: optical path difference Δn×d=287.3 nm, pre-tilt angle θ=89°, Ro=60 nm, Rth1=200 nm, Rth2=88.5 nm. Comparing FIG. 9a with FIGS. 1a and 1b, the dark state light leakage of the liquid crystal panel compensated by the above compensation architecture parameters concentrates around the vertical viewing angle, the light leakage area concentrates within the smaller viewing angle range, and the amount of light leakage is significantly lower than the dark state light leakage caused by the existing single-layer biaxial compensation. Comparing FIG. 9b with FIGS. 1b and 2b, the wide viewing angle contrast distribution of the liquid crystal panel compensated by the above compensation architecture parameters is significantly better than the wide viewing angle contrast distribution of the existing single-layer biaxial compensation, especially the contrast in the nearly horizontal viewing angle region has effective improvement. Under the circumstance of obtaining the above better effect, comparing to using the double-layer biaxial compensation film, the present invention reduces the use of the compensation film, lowering production costs.

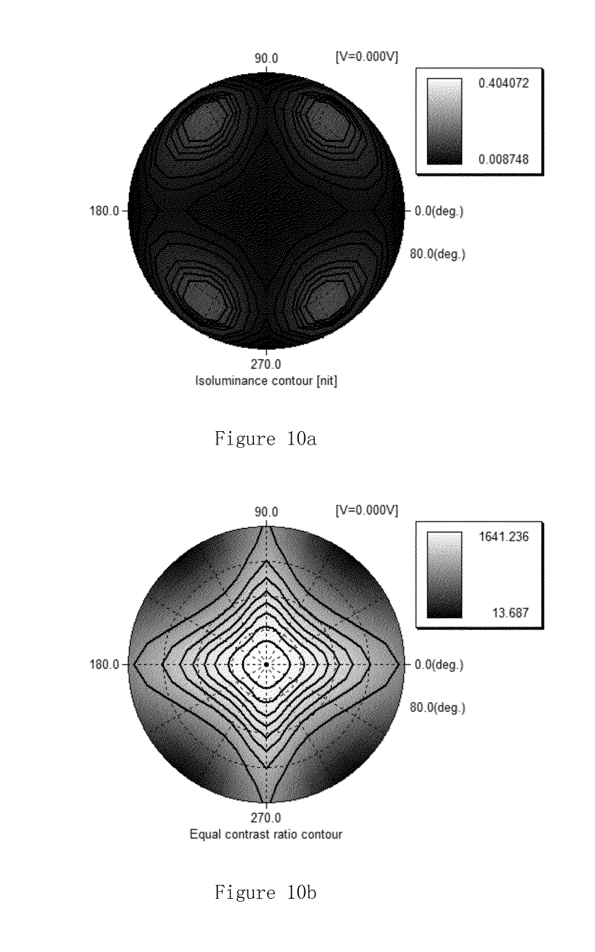

Referring to FIGS. 10a and 10b, FIG. 10a is another profile distribution of the dark full viewing angle isoluminant of a compensated liquid crystal panel in an embodiment, FIG. 10b is a profile distribution of the full viewing angle contrast of the liquid crystal panel shown in FIG. 10a. The setting conditions of FIGS. 10a and 10b are: optical path difference Δn×d=290 nm, the pretilt angle of θ=89°, Ro=60 nm, Rth1=200 nm, Rth2=88.5 nm. comparing FIG. 10a with 1a and 1b, the dark state light leakage of the liquid crystal panel compensated by the above compensation architecture parameters concentrates around the vertical viewing angle, the light leakage area concentrates within the smaller viewing angle range, and the amount of light leakage is significantly lower than the dark state light leakage caused by the existing single-layer biaxial compensation. Comparing FIG. 10b with FIGS. 1b and 2b, the wide viewing angle contrast distribution of the liquid crystal panel compensated by the above compensation architecture parameters is significantly better than the wide viewing angle contrast distribution of the existing single-layer biaxial compensation, especially the contrast in the nearly horizontal viewing angle region has effective improvement. Under the circumstance of obtaining the above better effect, comparing to using the double-layer biaxial compensation film, the present invention reduces the use of the compensation film, lowering production costs.

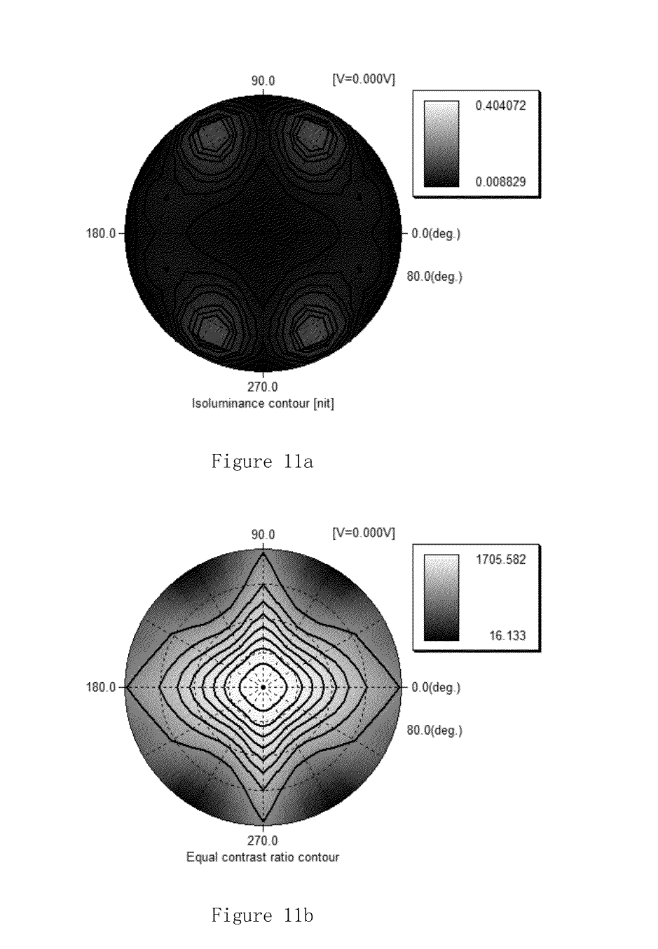

Referring to FIGS. 11a and 11b, FIG. 11a is a profile distribution of the dark full viewing angle isoluminant of a compensated liquid crystal panel in an embodiment, FIG. 11b is a profile distribution of the full viewing angle contrast of the liquid crystal panel shown in FIG. 9a. The setting conditions of FIGS. 9a and 9b are: optical path difference Δn×d=303 nm, pre-tilt angle θ=89°, Ro=72 nm, Rth1=240 nm, Rth2=59 nm. Comparing FIG. 11a with FIGS. 1a and 1b, the dark state light leakage of the liquid crystal panel compensated by the above compensation architecture parameters concentrates around the vertical viewing angle, the light leakage area concentrates within the smaller viewing angle range, and the amount of light leakage is significantly lower than the dark state light leakage caused by the existing single-layer biaxial compensation. Comparing FIG. 11b with FIGS. 1b and 2b, the wide viewing angle contrast distribution of the liquid crystal panel compensated by the above compensation architecture parameters is significantly better than the wide viewing angle contrast distribution of the existing single-layer biaxial compensation, especially the contrast in the nearly horizontal viewing angle region has effective improvement. Under the circumstance of obtaining the above better effect, comparing to using the double-layer biaxial compensation film, the present invention reduces the use of the compensation film, lowering production costs.

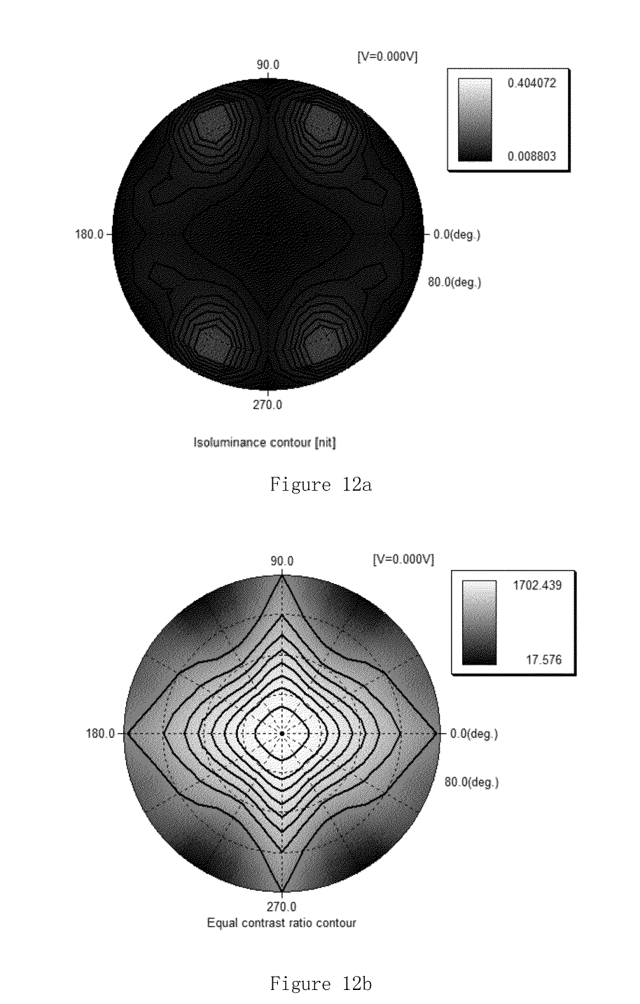

Referring to FIGS. 12a and 12b, FIG. 9a is a profile distribution of the dark full viewing angle isoluminant of a compensated liquid crystal panel in an embodiment, FIG. 12b is a profile distribution of the full viewing angle contrast of the liquid crystal panel shown in FIG. 12a. The setting conditions of FIGS. 9a and 9b are: optical path difference Δn×d=305.7 nm, pre-tilt angle θ=89°, Ro=72 nm, Rth1=240 nm, Rth2=59 nm. Comparing FIG. 12a with FIGS. 1a and 1b, the dark state light leakage of the liquid crystal panel compensated by the above compensation architecture parameters concentrates around the vertical viewing angle, the light leakage area concentrates within the smaller viewing angle range, and the amount of light leakage is significantly lower than the dark state light leakage caused by the existing single-layer biaxial compensation. Comparing FIG. 12b with FIGS. 1b and 2b, the wide viewing angle contrast distribution of the liquid crystal panel compensated by the above compensation architecture parameters is significantly better than the wide viewing angle contrast distribution of the existing single-layer biaxial compensation, especially the contrast in the nearly horizontal viewing angle region has effective improvement. Under the circumstance of obtaining the above better effect, comparing to using the double-layer biaxial compensation film, the present invention reduces the use of the compensation film, lowering production costs.

The specific value of the optical path difference Δn×d, the pretilt angle θ, Rth1 and TAC Rth2 provided by the above embodiments is only described as an example. According to the proving results, it can achieve the technical effect of the same or similar with the above-mentioned specific examples when the values of these parameters are within the following ranges: 287.3 nm≦Δn×d≦305.7 nm; 85°≦θ<90°; 180 nm≦Rth1≦260 nm; Y1 nm≦Rth2≦Y2 nm; Y1=−0.885×Rth1+241.9; Y2=−0.006638×(Rth1) 2.+1.95×Rth1−6.3 180 nm≦Rth1≦260 nm; Y1 nm≦Rth2≦Y2 nm; where, Y1=−0.885×Rth1+241.9; Y2=−0.006638×(Rth1) 2+1.95×Rth1−6.3. Particularly, when the compensation thickness Rth1 of the biaxially compensation film 13 is 200˜240 nm, the compensation thickness Rth2 of the second protective film is in the range of 59˜88.5 nm, the solution can obtain the better technical effect.

In conclusion, in the present invention, through setting a reasonable compensation value of the biaxially compensation film and the second protective film, it can deflect the angle which the dark state light leakage of the liquid crystal panel is serious from the horizontal viewing angle region to the vertical viewing angle region; moreover, it can effectively reduce the dark state light leakage of the liquid crystal panel and ensure that the light leakage concentrate in the smaller range. Compensating by combining the single-layer biaxial compensation film and the second protection film can not only solve the issue of using the single-layer biaxial compensation film, but also reduce the costs of the double-layer biaxial compensation film compensation.

It needs to notice that, in this article, the relational terms such as first and second is only used to distinguish one entity or operating another entity or an operation, it is not necessary to require or imply that there exists any such relationship or sequence between the entity and operation. Besides, the terms “comprise,” “include,” or any other variation are intended to cover a non-exclusive inclusion, thereby making that comprising a series of process, method, materials or apparatus of element not only comprise those elements, but also comprise other elements not expressly listed, or also comprise such inherent elements of process, method, materials or apparatus. In the absence of more restrictive conditions, limiting the elements by the statement “comprises a . . . ”, it doesn't exclude that it also exists other identical elements in comprising the process, method, materials or apparatus of element.

The above description is only the specific embodiment in the present invention, be noted that, for those ordinary technical personnel in this art, it also can be improved and modified under the circumstance of without disobeying the present application principle, these improvements and modifications are also considered in the scope of the present application.

What is claimed is:

1. A compensation architecture of a liquid crystal panel, which comprises a sequentially stacked protective film, a first polarizing film, a biaxial compensation film, a liquid crystal panel, a second protective film, a second polarizing film and a third protective film, wherein the liquid crystal panel is provided a liquid crystal layer including a plurality of liquid crystal molecules, the refractive index anisotropy of the liquid crystal layer is Δn, the thickness is d, the pretilt angle of liquid crystal molecules is θ; the compensation thickness of the biaxial compensation film is Rth1; the compensation thickness of the second protective film is Rth2, wherein:
287.3 nm≦Δn×d≦305.7 nm;
85°≦θ<90°;
180 nm≦Rth1≦260 nm;
Y1 nm≦Rth2≦Y2 nm;
Y1=−0.885×Rth1+241.9;
Y2=−0.006638×(Rth1) 2+1.95×Rth1−6.3

2. The compensation architecture of a liquid crystal panel as claimed in claim 1, wherein 290 nm≦Δn×d≦303 nm.

3. The compensation architecture of a liquid crystal panel as claimed in claim 1, wherein 200 nm≦Rth1≦240 nm; 59 nm≦Rth2≦88.5 nm.

4. The compensation architecture of a liquid crystal panel as claimed in claim 1, wherein the compensation thickness Rth2 of the second protective film is chosen 59 nm.

5. The compensation architecture of a liquid crystal panel as claimed in claim 1, wherein the material of the first polarizing film and the second polarizing film is polyvinyl alcohol.

6. The compensation architecture of a liquid crystal panel as claimed in claim 2, wherein the materials of the first polarizing film and the second polarizing film are polyvinyl alcohol.

7. The compensation architecture of a liquid crystal panel as claimed in claim 5, wherein the materials of the first protective film, the second protective film and the third protective film are cellulose triacetate.

8. The compensation architecture of a liquid crystal panel as claimed in claim 5, wherein the angle between the absorption axis of the first polarizing film and the slow axis of the biaxial compensation film is 90°.

9. The compensation architecture of a liquid crystal panel as claimed in claim 7, wherein the liquid crystal panel is the vertical alignment.

10. The compensation architecture of a liquid crystal panel as claimed in claim 8, wherein the liquid crystal panel is the vertical alignment.

11. A liquid crystal display device, which comprises a liquid crystal display panel and a backlight module, the liquid crystal display panel and the backlight module being disposed relatively, the backlight module providing a display light to the liquid crystal display panel in order to make the liquid crystal display panel display the image, wherein the liquid crystal display panel is compensated by a compensation architecture, the compensation architecture comprises a sequentially stacked protective film, a first polarizing film, a biaxial compensation film, a liquid crystal panel, a second protective film, a second polarizing film and a third protective film, wherein the liquid crystal panel is provided a liquid crystal layer including a plurality of liquid crystal molecules, the refractive index anisotropy of the liquid crystal layer is Δn, the thickness is d, the pretilt angle of liquid crystal molecules is θ; the compensation thickness of the biaxial compensation film is Rth1; the compensation thickness of the second protective film is Rth2, wherein:
287.3 nm≦Δn×d≦305.7 nm;
85°≦θ<90°;
180 nm≦Rth1≦260 nm;
Y1 nm≦Rth2≦Y2 nm;
Y1=−0.885×Rth1+241.9;
Y2=−0.006638×(Rth1) 2+1.95×Rth1−6.3

12. The compensation architecture of a liquid crystal panel as claimed in claim 11, wherein 290 nm≦Δn×d≦303 nm.

13. The compensation architecture of a liquid crystal panel as claimed in claim 11, wherein 200 nm≦Rth1≦240 nm; 59 nm≦Rth2≦88.5 nm.

14. The compensation architecture of a liquid crystal panel as claimed in claim 11, wherein the compensation thickness Rth2 of the second protective film is chosen 59 nm.

15. The compensation architecture of a liquid crystal panel as claimed in claim 11, wherein the material of the first polarizing film and the second polarizing film is polyvinyl alcohol.

16. The compensation architecture of a liquid crystal panel as claimed in claim 12, wherein the materials of the first polarizing film and the second polarizing film are polyvinyl alcohol.

17. The compensation architecture of a liquid crystal panel as claimed in claim 15, wherein the materials of the first protective film, the second protective film and the third protective film are cellulose triacetate.

18. The compensation architecture of a liquid crystal panel as claimed in claim 15, wherein the angle between the absorption axis of the first polarizing film and the slow axis of the biaxial compensation film is 90°.

19. The compensation architecture of a liquid crystal panel as claimed in claim 17, wherein the liquid crystal panel is the vertical alignment.

20. The compensation architecture of a liquid crystal panel as claimed in claim 18, wherein the liquid crystal panel is the vertical alignment.
